(19) United States
(12) Patent Application Publication
(10) Pub. No.: US 2007/0192188 A1
(43) Pub. Date: Aug. 16, 2007

(54) METHODS FOR REAL ESTATE INVESTMENT, DEVELOPMENT, AND SALES

(75) Inventor: Ryan N. Gregerson, Cedar City, UT (US)

Correspondence Address: STOEL RIVES LLP - SLC, 201 SOUTH MAIN STREET, ONE UTAH CENTER, SALT LAKE CITY, UT, 84111, US

(73) Assignee: IDR Investment Plan, LLC, Cedar City, UT (US)

(21) Appl. No.: 11/428,157

(22) Filed: Jun. 30, 2006

Related U.S. Application Data
(60) Provisional application No. 60/772,071, filed on Feb. 10, 2006.
(60) Provisional application No. 60/780,663, filed on Mar. 9, 2006.

(51) Int. Cl. G06Q 30/00

(52) U.S. Cl. 705/14

(57) ABSTRACT

Methods are provided for real estate investment, development, and ownership. The methods allow multiple users to combine their resources to purchase, make improvements to, and individually own and/or sell real property. The users save money or realize greater profits on real estate transactions by taking on the roles of upstream investors, developers and real estate agents. In one embodiment, undivided interests in a real property are sold to a plurality of buyers. The buyers each pay a portion of a cost for making an improvement to the real property. In one embodiment, the buyers only pay a guaranteed estimate for the improvement costs. Upon selling the undivided interests, each buyer also reserves one or more portions of the real property. When the improvement to the real property is complete, sole ownership of the reserved portions are transferred to the respective buyers. In one embodiment, the buyers receive a discount for referring other buyers that also purchase an interest in the real property.

### RELATED APPLICATIONS

This application claims the benefit under 35 U.S.C. § 119(e) of U.S. Provisional Application No. 60/772,071, filed Feb. 10, 2006, and U.S. Provisional Application No. 60/780,663, filed Mar. 9, 2006, both of which are hereby incorporated by reference herein in their entirety.

### TECHNICAL FIELD

This disclosure relates generally to methods for investing in, developing, and selling real estate.

### BRIEF DESCRIPTION OF THE DRAWINGS

Non-limiting and non-exhaustive embodiments of the disclosure are described, including various embodiments of the disclosure with reference to the figures, in which:

FIG. 1 is a flow chart of a method for real estate investment, development, and sales according to one embodiment;

FIG. 2 is a graphical representation of an exemplary plat map generally used to plan a residential development project;

FIG. 3 is a graphical representation of a referral discount chart according to one embodiment;

FIG. 4 is a block diagram illustrating relationships between entities involved in real estate investment, development and sales according to one embodiment;

FIG. 5 is a flow chart illustrating an exemplary real property investment, development, and sales process involving the entities shown in FIG. 4 according to one embodiment;

FIG. 6 is a flow chart illustrating an exemplary real property investment, development, and sales process according to another embodiment; and

FIG. 7 is a flow chart illustrating an exemplary real property investment, development, and sales process according to another embodiment.

### DETAILED DESCRIPTION

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

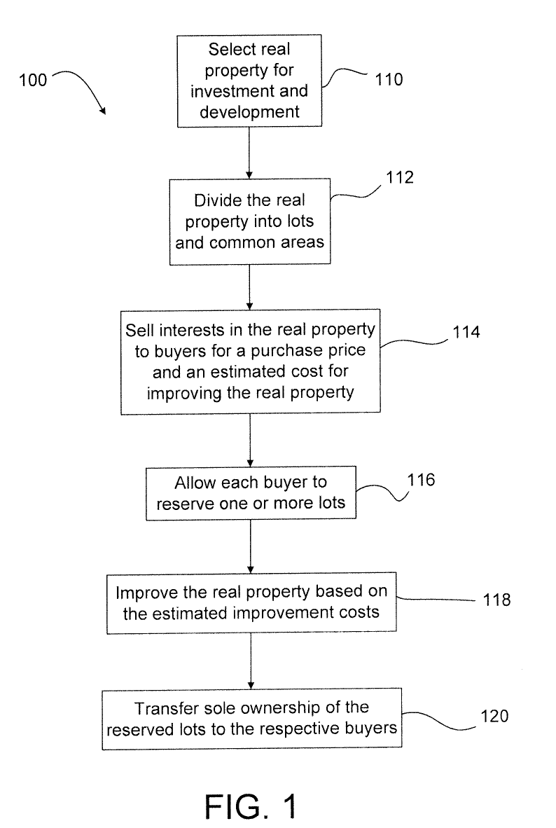

FIG. 1 is a flow chart of a method 100 for real estate investment, development, and sales according to one embodiment. The method 100 allows multiple users to combine their resources to purchase real property, make improvements to the real property, and individually own and/or sell portions of the real property for their own benefit. Developed real estate is generally expensive because one or more investors may profit from buying and selling the real estate, a land developer may profit from making improvements to the real estate, and a real estate agent may profit from selling the improved real estate to one or more buyers. However, the method 100 shown in FIG. 1 allows multiple users to save money or realize greater profits on real estate transactions by taking on the roles of upstream investors, developers and real estate agents.

The method 100 includes selecting 110 real property for development. Selecting 110 the real property may include, for example, researching real property markets to find land with a high potential return on investment. For example, undeveloped land may be selected that is on the outskirts of a city with current and projected expansion. Artisans will recognize from the disclosure herein that a variety of factors are known for identifying real property that is likely to increase in value, including factors such as being located near freeways or other high traffic areas, being located in or near recreational areas, being located near developments with high resell value, a combination of the foregoing, or other real estate market factors.

Once the real property is selected, the real property is purchased for investment and development. As discussed in detail below, in one embodiment, the selected real property is purchased by an investment coordinator. In other embodiments, the coordinator already owns the real property or performs coordination as discussed herein for a third party seller of the real property. An artisan will recognize from the disclosure herein that some embodiments do not use the services of a coordinator.

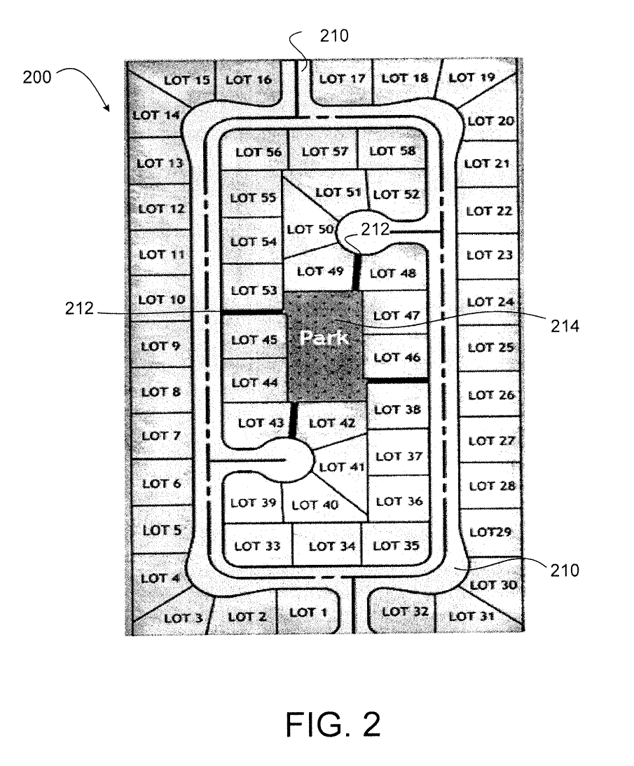

The method 100 also includes dividing 112 the real property into future or proposed lots and common areas. For example, FIG. 2 is a graphical representation of an exemplary plat map 200 generally used to plan a residential development project. The plat map 200 defines how the real property is to be subdivided into individual proposed lots (e.g., LOT 1 through LOT 58 are shown in this example) and common areas such as streets 210, paths 212, and recreational areas 214 (e.g., parks, community swimming pools, lakes, tennis courts, golf courses, and the like).

Although not shown in FIG. 2, the plat map 200, or another document, may also define easements for water lines, sewer lines, gas lines, electrical lines, communication lines, other utilities, and sidewalks. As is known in the art, covenants, codes, and/or restrictions may also be defined for how the property may be used (e.g., types of homes that may be built on the proposed lots, landscaping requirements, time tables for starting and completing homes and/or landscaping on the proposed lots, construction and renovation approval processes, and the like). While the plat map 200 shown in FIG. 2 is for a residential development project, an artisan will recognize from the disclosure herein, that the real property may also be developed for other purposes including, for example, commercial, recreational, agricultural, transportation, a combination of the foregoing, or other uses.

Returning to FIG. 1, the method 100 also includes selling 114 interests in the real property to buyers for a purchase price and an estimated cost for improving the real property. In one embodiment, each buyer purchases an undivided interest in the real property such that the deed they receive for their interest does not specify a particular portion of the real property that they own. Rather, in one embodiment, each buyer is a tenant in common with the other buyers and/or with the entity from which they purchased their interest (e.g., the coordinator discussed below). An artisan will recognize from the disclosure herein that the buyers' undivided interests may take on other forms including, for example, joint tenancy.

As a condition of selling the undivided interest in the real property to the buyers, each buyer agrees to pay a portion of the estimated cost of improving the real property. The improvements include, for example, building streets, curbs, gutters, sidewalks, paths, recreational areas, water lines, sewer lines, gas lines, electrical lines, and/or communication lines. In addition to the improvements, the improvement costs may include, for example, engineering and surveying costs for planning and subdividing the real property.

In one embodiment, each buyer's portion of the improvement costs is proportional to their respective interest purchased in the real property. In one embodiment, for example, a first buyer that purchases a 1/100^{th} interest in the real property would also pay 1% of the improvement costs, a second buyer that purchases a 1/50^{th} interest in the real property would also pay 2% of the improvement costs, and so forth. As discussed in detail below, in one embodiment, the buyers become members of a development company that makes the improvements to the real property. The buyers' respective ownership in the development company is proportional to their respective interest in the real property.

The method also includes allowing 116 each buyer to reserve one or more future or proposed lots. Although each buyer purchases an undivided interest in the real property, each buyer agrees with the other owners of the real property to a reservation of one or more proposed lots that the buyer will own as a sole owner after the improvements have been made to the real property. In one embodiment, the purchase price of a buyer's interest in the real property is based on the value of the particular proposed lot or lots that the buyer chooses to reserve. For example, the purchase price of a particular reserved proposed lot may be based on factors such as relative size as compared to the other proposed lots, location, and other geographical features of the particular proposed lot.

The purchase price also includes the value of the common areas. If, for example, the real property comprises 35 acres of undeveloped land that is to be subdivided into 10 acres of common area (e.g., streets, paths, parks, and the like) and 100 proposed lots of equal value that are each 0.25 acre, then each buyer's purchase price for their respective interest (based on reserving a single proposed lot) would be equal to the market value of 0.35 acre. In one embodiment, the cost of the common area (e.g., the 10 acres in the above example) is divided equally among the proposed lots regardless of the size or value of the individual proposed lots. In other embodiments, the cost of the common area is allocated to each proposed lot in proportion to the value of the proposed lot. Thus, a first buyer who reserves a more expensive proposed lot pays for more of the cost of the common area than a second buyer who reserves a less expensive proposed lot.

The coordinator sells 114 interests in the real property until all or a desired number of proposed lots have been reserved by the buyers. In one embodiment, the coordinator sells the interests in the real property by providing discounts or refunds on a portion of the purchase price to buyers who refer or recommend other buyers that also buy an interest in the real property. Thus, rather than paying a commission to a realtor to help sell interests in the land, a first buyer who has purchased an interest in the real property receives a financial benefit when the first buyer refers a second buyer who also purchases an interest in the real property. In one embodiment, the first buyer also receives a financial benefit when the second buyer refers a third buyer that purchases an interest in the real property, and so forth.

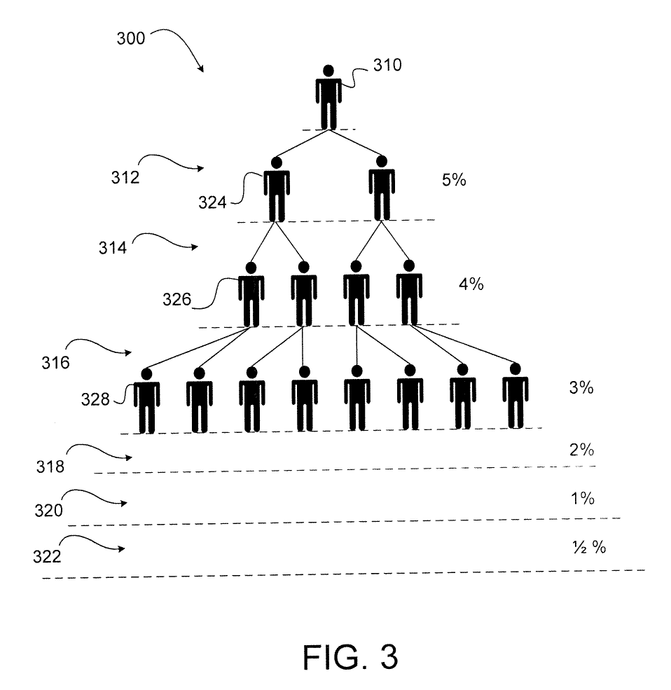

For example, FIG. 3 is a graphical representation of a referral discount chart 300 according to one embodiment. The referral discount chart 300 includes a first buyer 310 who has purchased an interest in the real property. The referral discount chart 300 also includes a first discount level 312, a second discount level 314, a third discount level 316, a fourth discount level 318, a fifth discount level 320, and a sixth discount level 322. The first discount level 312 includes one or more second buyers 324 (two shown) to whom the first buyer 310 recommended purchasing interests in the real property. In one embodiment, for each of the second buyers 324 that purchase an interest in the real property, the first buyer 310 receives a 5% discount or refund of the first buyer's purchase price for the real property.

The second discount level 314 includes one or more third buyers 326 (four shown) referred by one or more of the second buyers 324. For each of the third buyers 326 that purchases an interest in the real property, the first buyer 310 receives a 4% discount of the first buyer's purchase price for the real property. In one embodiment, the second buyers 324 that referred the respective third buyers also receive a 5% discount of the respective second buyers' purchase price for the real property. The third discount level 316 includes one or more fourth buyers 328 (eight shown) referred by one or more of the third buyers 326. For each of the fourth buyers 328 that purchases an interest in the real property, the first buyer 310 receives a 3% discount or refund of the first buyer's purchase price for the real property. In one embodiment, the third buyers 326 that referred the respective fourth buyers 328 also receive a 5% discount, and the second buyers 324 that referred the respective third buyers 326 receive a 4% discount.

Although not shown in FIG. 3, the fourth level 318 includes one or more buyers referred by one or more of the fourth buyers 328, the fifth level 320 includes one or more buyers referred by one or more of the buyers in the fourth level 318, and the sixth level 322 includes one or more buyers referred by one or more of the buyers in the fifth level 320. In one embodiment, the first buyer 310 receives a 2% discount for each buyer in the fourth level 318 that purchases an interest in the real property, a 1% discount for each buyer in the fifth level 320 that purchases an interest in the real property, a 0.5% discount for each buyer in the sixth level 322 that purchases an interest in the real property, and so forth.

By way of example, if the first buyer 310 refers two second buyers 324, the two second buyers 324 each refer two third buyers 326, and each of the third buyers 326 refer two fourth buyers 328, then the first buyer 310 would receive a 50% discount or refund of the first buyer's purchase price. Further, the two second buyers 324 would each receive a 26% discount. In addition, the four third buyers 326 would each receive a 10% discount. Assuming the purchase price for each of the buyers 310, 324, 326, 328 to be substantially the same, the total discounts provided in this example is less than the total commissions that would be paid to a realtor receiving, for example, a 10% commission for each of the fifteen buyers 310, 324, 326, 328. Thus, the buyers 310, 324, 326 save money by acting as their own realtors after owning an interest in the real property.

An artisan will recognize that the disclosure herein is not limited to the specific discounts discussed above with respect to FIG. 3, and that many different percentage discounts or combinations of discounts could be used. For example, in one embodiment, the buyers 310, 324, 326, 328 receive discounts only when a predetermined number of interests are sold at each level 312, 314, 316, 318, 320, 322. The first buyer 310 may receive a 5% discount, for example, for referring each of the second buyers 324 in the first level 312. However, for the second level 314, the first buyer 310 may receive only a 4% discount each time four third buyers 326 purchase an interest in the real property. Similarly, the first buyer 310 may receive a 3% discount for eight referrals in the third level 316, a 2% discount for 16 referrals in the fourth level 318, a 1% discount for 32 referrals in the fifth level 320, and a 0.5% discount for 64 referrals in the sixth level 322.

As another example of an alternative method of providing referral discounts, in one embodiment the total discount provided for a sale of an interest in the real property is limited to a predetermined percentage of the interest being sold. Thus, if a fourth buyer 328 purchases an interest in the real property and the total referral payout is limited to 10%, for example, then the first buyer 310 may receive 3% of the purchase price, the second buyer 324 in the referral chain may receive 3.25% of the purchase price, and the third buyer 326 in the referral chain may receive 3.75% of the purchase price. Other distributions of the referral payout percentage are also possible including, for example, providing a higher percentage to the first buyer 310 than to the second buyer 324, and providing a higher percentage to the second buyer 324 than to the third buyer 326.

Returning again to FIG. 1, the method 100 also includes improving 118 the real property based on the estimated improvement costs. As discussed above, in one embodiment, the buyers become members of a development company that makes the improvements to the real property. In one embodiment, the development company hires a third party development manager to make the improvements to the real property. As discussed above, the improvements may include, for example, building streets, curbs, gutters, sidewalks, paths, recreational areas, water lines, sewer lines, gas lines, electrical lines, and/or communication lines.

The method 100 further includes transferring 120 sole ownership of the reserved lots to the respective buyers. In one embodiment, the sole ownership of the reserved lots are transferred to respective buyers after the improvements to the real property are substantially complete. Thus, instead of owning an interest in undeveloped property along with other buyers, each buyer becomes a sole owner of one or more improved lots that the buyer previously reserved. After becoming a sole owner of a lot, a buyer may, for example, build a home on the lot, lease the lot, and/or sell the lot.

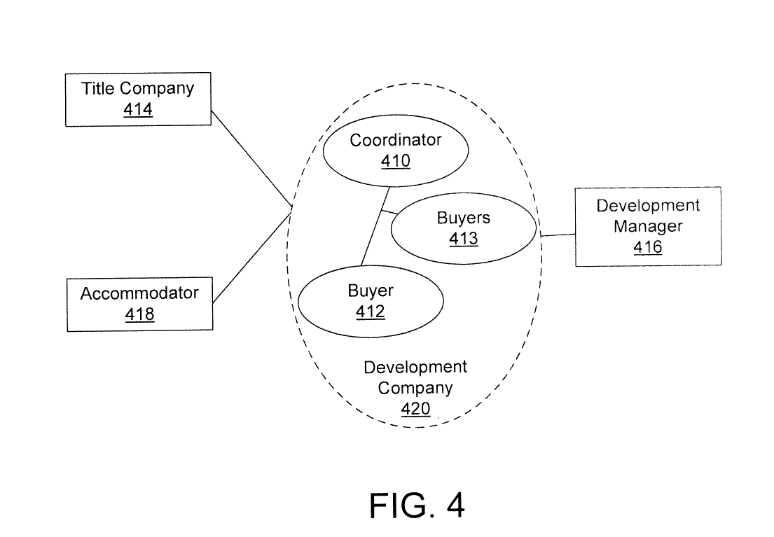

FIG. 4 is a block diagram illustrating relationships between entities involved in real estate investment, development and sales according to one embodiment. The entities include a coordinator 410, buyers 412, 413, a title company 414, a development manager 416, and an accommodator 418. The coordinator 410 may be a seller of a real property. The coordinator 410 may purchase the real property as an investment for the coordinator 410 and/or the buyers 412, 413. In other embodiments, the coordinator 410 may be hired by a seller of the real property developing and selling the real property. The title company may be, for example, a title and/or escrow company, as is known in the art.

The buyers 412, 413 may be individuals, groups of individuals (e.g., spouses, investment groups, or other groups), or other entities such as corporations. For illustrative purposes in the example below, the buyers 412, 413 include an individual buyer 412 and one or more other buyers 413. As discussed in detail herein, the coordinator 410, the title company 414, the development manager 416, and the accommodator 418 perform services that allow the buyers 412, 413 to invest in real property, collectively make improvements to the real property, and divide the real property after the improvements are made for sole ownership by the respective buyers 412, 413. An artisan will recognize from the disclosure herein that other embodiments do not use one or more of the coordinator 410, the title company 414, the development manager 416, and the accommodator 418. For example, the buyers 412 and/or the accommodator 418 may perform some or all of the services of the coordinator 410 as described herein. As another example, the title company 414 may perform some or all of the services of the accommodator 414 as described herein.

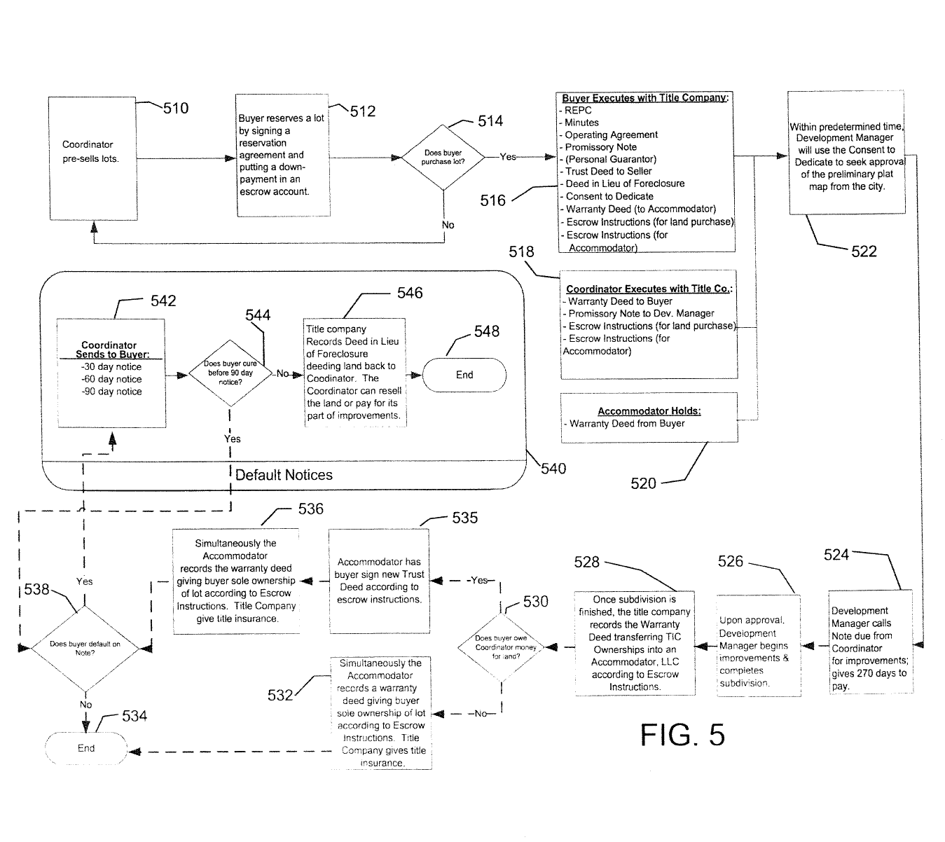

FIG. 5 is a flow chart illustrating an exemplary real property investment, development, and sales process involving the entities shown in FIG. 4 according to one embodiment. Referring to FIGS. 4 and 5, at a block 510, the coordinator 410 pre-sells future or proposed lots in an undeveloped piece of real property. As discussed above, in one embodiment, the coordinator 410 generates a plat map (see FIG. 2) that defines how the real property is to be divided into individual proposed lots and common areas. The buyers 412, 413 purchase undivided interests in the real property and reserve proposed lots, as discussed above.

The buyers 412, 413 also purchase, in one embodiment, memberships in a development company 420 that controls and pays for improvements to the real property. In another embodiment, the buyers 412, 413 become members of the development company 420 without purchasing the memberships. Rather than making a separate purchase, for example, the buyer 412 becomes a member of the development company 420 when by purchasing the undivided interests in the real property and agree to pay for the improvements to the real property. In one embodiment, the coordinator 410 also reserves one or more of the proposed lots and is a member of the development company 420.

The development company 420 hires the development manager 416 to perform the improvements to the real property. The coordinator 410 and/or the development manager 416 define the improvements to be made to the real property. The improvements include, for example, building streets, curbs, gutters, sidewalks, paths, recreational areas, water lines, sewer lines, gas lines, electrical lines, and/or communication lines. In one embodiment, the development manager 416 provides an estimated cost of the improvements. The estimated cost of the improvements may include, for example, estimated construction costs, legal costs, accounting costs, property taxes, and/or management fees.

At a block 512, the buyer 412 reserves a proposed lot by signing a reservation agreement and putting a down payment for a purchase price in an escrow account. The escrow account may be controlled, for example, by the title company 414. The reservation agreement specifies a particular proposed lot that the buyer 412 has selected for sole ownership after the improvements have been made to the real property. The reservation agreement includes an agreement for “closing” the reservation agreement by creating an undivided interest for the buyer 412 in the real property.

During the time between signing the reservation agreement and deciding whether to close the reservation agreement at a block 514, the buyer 412 may, for example, inspect the real property, investigate ownership rights of the real property, secure financing for purchasing the interest in the real property, and/or satisfy other conditions of the reservation agreement. The coordinator 410 may also use this time, for example, to investigate the buyer's credit history and/or satisfy conditions of the reservation agreement.

At the block 514, the coordinator 410 and the buyer 412 decide whether the conditions of the reservation agreement have been met so as to close on the reservation agreement. If not, the coordinator 410 may resell the interest in the real property corresponding to the particular reserved proposed lot to one of the other buyers 413 and refund at least a portion of the down payment to the buyer 412. If the coordinator 410 and the buyer 412 decide to close on the reservation agreement, at blocks 516, 518, the buyer 412 and the coordinator 410 execute a plurality of documents with the title company 414 to create an undivided interest for the buyer 412 in the real property. For example, at the block 516, the buyer 412 may execute a real estate purchase contract (REPC), minutes, and an operating agreement.

In the REPC, the buyer 412 agrees to purchase an undivided interest in the real property. As discussed herein, in one embodiment, the undivided interest is a tenancy in common with the other buyers 413 and/or the coordinator 410. The REPC includes the purchase price and down payment amounts of the interest in the real property and estimated improvement costs. In one embodiment, the coordinator 410 agrees to pay for or reimburse the buyer 412 for improvement costs that exceed the estimate. To reduce the coordinator's risk in one such embodiment, the coordinator 410 only agrees to pay for the portion of the improvement costs that exceed the estimate if the initial development manager 416 is managing the development company 420. Thus, the buyers 412, 413 are less likely to replace the initial development manager 416 with an individual or company that would likely exceed the estimated cost of improvements.

In the REPC, the coordinator 410 and the buyer 412 agree to the real property investment, development, and sales process as shown in FIG. 5 and discussed herein, including, for example, agreeing to execute the documents discussed herein, agreeing that the buyer 412 will become an owner in the development company 420, agreeing to allocation of tax liabilities, agreeing that the REPC will not terminate and merge with the warranty deed from the coordinator 410 to the buyer 412, and other provisions generally included in real estate purchase agreements. In one embodiment, the REPC also defines referral discounts, as discussed herein, provided to the buyer 412 for referring one or more of the other buyers 413. In one embodiment, the REPC also includes an agreement that if the city and/or county in which the real property is located requires changes to the proposed plat map that changes the buyer's reserved proposed lot, the development manager 416 will assign a similar proposed lot to the buyer 412.

The minutes define an organizational meeting and resolution of the development company 420 and is signed by the buyer 412. The minutes add the buyer 412 as a new member of the development company 420, name an initial development manager 416, and set a date in which to begin the annexation approval process in the city and/or county in which the real property is located. In one embodiment, if the city and/or county will not give approval to annex the proposed subdivision, the coordinator 410 agrees to purchase the undivided interests from the buyers 412, 413 and the development company 420 is dissolved.

The operating agreement defines membership rights and obligations in the development company 420. The portion of ownership in the development company is in proportion to the buyer's undivided interest in the real property. In one embodiment, the operating agreement designates the coordinator 410 as an initial member and defines requirements for adding additional and/or substitute members to the development company 420. For example, in one embodiment, additional and/or substitute members must be approved by the development manager 416 who verifies that the additional and/or substitute members own an interest in the real property and have agreed to develop the real property as discussed herein. In one embodiment, the buyer 412 agrees not to transfer the buyer's undivided interest in the real property to a third party without the development manager's approval of the third party for membership in the development company 420.

The operating agreement may also define membership voting rights (e.g., circumstances in which majority or unanimous vote are required, quorum, proxy voting, and the like), financing (e.g., member contributions, allocation of profit/loss, member capital accounts, and the like), management (e.g., defining compensation, powers, authority and fiduciary duties of the development manager 416, naming the development manager 416, granting agency and/or power of attorney to the development manager 416, and the like), dissolution, and other agreements generally included in corporate, partnership and/or limited liability company agreements. In one embodiment, the operating agreement specifies that the development company 420 will be dissolved when the development manager 416 finishes the improvements to the real property and individual lots are deeded to the members.

If the buyer 412 is borrowing money to pay for the interest in the real property and/or the buyer's portion of the improvements thereto, the buyer 412 also executes a promissory note. In one embodiment, for example, the promissory note includes an agreement that the buyer 412 will make a balloon payment to the coordinator 410 after a predetermined time (e.g., after twelve months) to repay the loan amount and accrued interest. Some lending institutions may be hesitant to loan the buyer 412 the purchase price for the interest in the land and the estimated cost to develop the land. A bank, for example, may only be willing to loan the buyer 412 the appraised price of the undivided interest in the undeveloped property. Further, the bank may not be willing to immediately loan the buyer a new appraisal value once improvements are made to the property. Thus, in some embodiments, the coordinator 410 loans the buyer 412 a portion of the purchase price for the interest in the real property and the buyer's portion of the estimated improvements to the real property.

In this example, the buyer 412 borrows at least a portion of the purchase price and/or the buyer's portion of the improvement costs from the coordinator 410. Thus, the buyer 412 executes the promissory note 412 to the coordinator 410. If the buyer 412 is purchasing the undivided interest in the real property on behalf of another entity, such as a trust or corporation, the buyer 412 may also execute a personal guarantee in which the buyer 412 agrees to be held personally responsible for completing the duties and obligations of a debtor to the coordinator 410 in the event that the buyer 412 fails to fulfill the terms of the promissory note. The buyer 412 may also execute a trust deed that transfers title to a trustee (e.g., the title company 414), which holds the interest in the real property as security for the loan. The buyer 412 may also execute a deed in lieu of foreclosure that transfers the interest in the real property to the lender (e.g., the coordinator 410 in this example) in case of default on the loan.

The buyer 412 may also execute a consent to dedicate that may be used to dedicate areas of the real property such as streets and parks to a city or county where the real property is located. The consent to dedicate may be necessary, for example, before the city or county approves the plat map.

The buyer 412 also executes a warranty deed that transfers the buyer's undivided interest in the real property to the accommodator 418. As discussed below, this allows the accommodator 418 to transfer sole ownership in the reserved proposed lot to the buyer 412 after the improvements to the real property are complete. At a block 520, the accommodator 418 holds the warranty deed from the buyer 412 without recording it until conditions set forth in instructions to the accommodator from the coordinator 410 and the buyer 412 are satisfied, as discussed below.

At the block 518, the coordinator 410 executes a warranty deed to the buyer 412. In one embodiment, the warranty deed from the coordinator 410 to the buyer 412 grants the buyer 412 title to the real property as a tenant in common with the coordinator 410 and/or the other buyers 413. The title company 414 provides title insurance to the buyer 412 as a tenant in common. In one embodiment, the title company 414 immediately proceeds to record the warranty deed from the coordinator 410 to the buyer 412.

Although not shown, in one embodiment, the coordinator 410 also executes a promise to the buyer 412 that within a predetermined period of time, if the buyer 412 does not have sole title to the buyer's reserved lot through no fault of the buyer 412, the coordinator 410 will purchase the buyer's undivided interest in the real property by refunding the buyer's down payment and voiding the buyer's promissory note. In addition, or in other embodiments, the coordinator 410 promises the buyer 412 that, if the improvement costs are more than the estimated improvement costs provided to the buyer 412, the coordinator 410 will pay or reimburse the buyer 412 for the difference between the actual improvement costs and the estimated improvement costs.

In one embodiment, the coordinator 410 also executes a promissory note to the development manager 416 to pay for the improvements to the real property. In the promissory note, the coordinator 410 agrees to make a balloon payment at a predetermined time and/or under specified conditions to the development manager 416 to pay for the improvements to the real property. In one embodiment, the balloon payment is also used to post a bond with the city and/or county in which the real property is located to guarantee completion of the improvements as approved by the city and/or county. With the bond for the improvements, other lending institutions (e.g., banks) are more likely to lend money to the buyers 412, 413 for the real property and the costs of making the improvements to the real property. Thus, the buyers 412, 413 that borrowed funds from the coordinator 410 may seek other loans to pay off their debts to the coordinator 410.

The coordinator 410 and the buyer 412 execute escrow instructions for the title company 414 for the purchase of the undivided interest in the real property and escrow instructions for the accommodator 418. The escrow instructions instruct the title company 414 and the accommodator 418 on their respective duties as agreed to by the coordinator 410 and the buyer 412. Those duties include the services discussed herein that are provided by the title company 414 and the accommodator 418. For example, in one embodiment, the accommodator 418 is instructed, among other things, to receive an affidavit of performance from the development manager 416 indicating that the improvements to the real property are complete before the accommodator 418 transfers sole ownership of the reserved lot to the buyer 412.

At a block 522, within the predetermined time after the coordinator 410 and the buyer 412 execute the documents discussed above, the development manager 416 uses the consent to dedicate (and the other buyers 413) to seek approval of the preliminary plat map from the city and/or county in which the real property is located. The city and/or county may require changes to the preliminary plat map. Thus, as part of the reservation agreement, the buyer 412 agrees to reasonable changes to the buyer's reserved proposed lot. At a block 524, the development manager 416 also calls the promissory note due from the coordinator 410 to pay for the improvements to the real property. The development manager 416 allows the coordinator 410 a predetermined amount of time (e.g., 270 days in this example) to make the balloon payment for the promissory note.

At a block 526, upon approval of the city and/or county of the plat map and improvements to the real property, the development manager 416 begins the improvements to the real property and substantially completes the subdivision. At a block 528, once the subdivision is finished, the title company 414 records the warranty deed from the buyer 412 to the accommodator 418 according to the escrow instructions. The title company 414 also records warranty deeds from the other buyers 413 and/or the coordinator 410 to the accommodator 418. Thus, the tenant in common (TIC) interests of the buyer 412, the other buyers 413 and/or the coordinator 410 are all transferred to the accommodator 418. Thus, the tenancy in common is ended and rights to sell or assign the real property are transferred to the accommodator 418.

At a block 530, the accommodator 418 queries whether the buyer 412 owes the coordinator 410 money for the buyer's interest in the real property and/or the improvements thereto. If the buyer 412 does not owe the coordinator 410 money, at a block 532, the accommodator 418 simultaneously (e.g., at the same time that the title company 414 records the warranty deed from the buyer 412 to the accommodator 418) records a warranty deed from the accommodator 418 that grants the buyer 412 sole ownership of the lot that the buyer 412 reserved, according to the escrow instructions. The title company 414 also gives title insurance to the buyer 412 as sole owner of the lot. In one embodiment, the buyer 412 may decide whether or not to purchase the title insurance from the title company 414. At a block 534, the process ends and the buyer 412 may take possession of the buyer's purchased lot for the buyer's own use and enjoyment. The buyer 412 may, for example, build a home on the lot and/or sell the lot.

If the buyer 412 owes the coordinator 410 money, at a block 535, the accommodator 418 has the buyer 412 execute a new trust deed according to escrow instructions. The new trust deed transfers title to a trustee (e.g., the title company 414), which holds the interest in the real property as security for the money owed to the coordinator 410. At a block 536, the accommodator 418 simultaneously (e.g., at the same time that the title company 414 records the warranty deed from the buyer 412 to the accommodator 418 and the buyer 412 executes the new trust deed) records a warranty deed from the accommodator 418 that grants the buyer 412 sole ownership of the lot that the buyer 412 reserved, according to the escrow instructions. The title company 414 also gives title insurance to the buyer 412 as sole owner of the lot. As discussed above, in one embodiment, the buyer 412 may decide whether or not to purchase the title insurance from the title company 414.

At a block 538, the coordinator 410 queries whether the buyer defaults on the promissory note from the buyer 412 to the coordinator 410. If the buyer 412 does not default on the promissory note (e.g., the buyer 412 makes regularly scheduled payments as agreed and/or pays off the loan amount), then the process ends at the block 534 as discussed above. However, if the buyer 412 defaults on the promissory note, then the process proceeds to a default notices block 540 for handling the default.

In a block 542, the coordinator 410 sends the buyer 412 one or more notices that the buyer 412 is in default. In this example, the coordinator 410 sends the buyer 412 a thirty day notice, a sixty day notice, and a ninety day notice. At a block 544, the coordinator 410 queries whether the buyer 412 cures the default before the ninety day notice. If the buyer 412 does cure the default, the process returns to the block 538. If the buyer 412 does not cure the default, at a block 546, the title company 414 records the deed in lieu of foreclosure that deeds the buyer's interest (which is now sole ownership in the buyer's reserved lot) to the coordinator 410. The coordinator 410 may then resell the lot and/or pay for the portion of the improvement costs corresponding to the lot. The process then ends at a block 548.

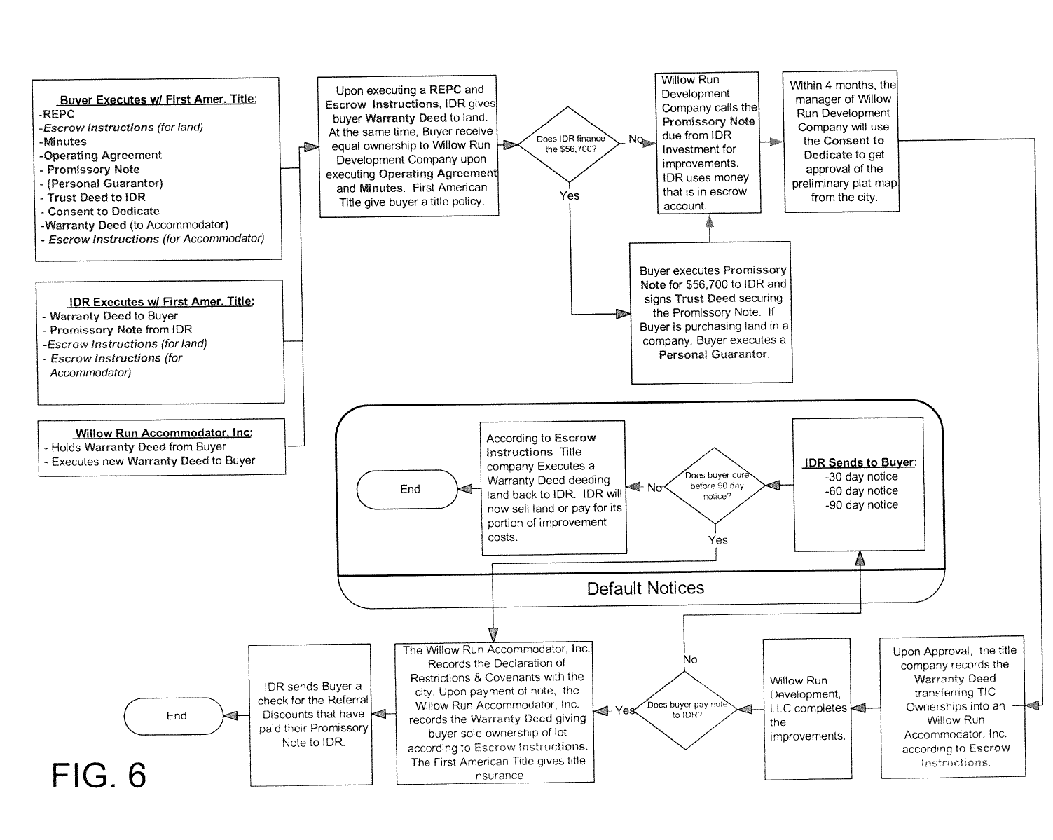

FIG. 6 is a flow chart illustrating an exemplary real property investment, development, and sales process according to another embodiment. In this embodiment, the coordinator 410 is called “IDR,” the title company 414 is called “First Amer. Title,” the accommodator 418 is called “Willow Run Accommodator, Inc.,” and the development company 420 is called “Willow Run Development, LLC” or “Willow Run Development Company.” An artisan will recognize that each of the foregoing entities may be one or more separate entities. An artisan will also understand that the process shown in FIG. 6 is provided by way of example only, and that the documents and terminology referenced in FIG. 6 are to be understood from the disclosure herein.

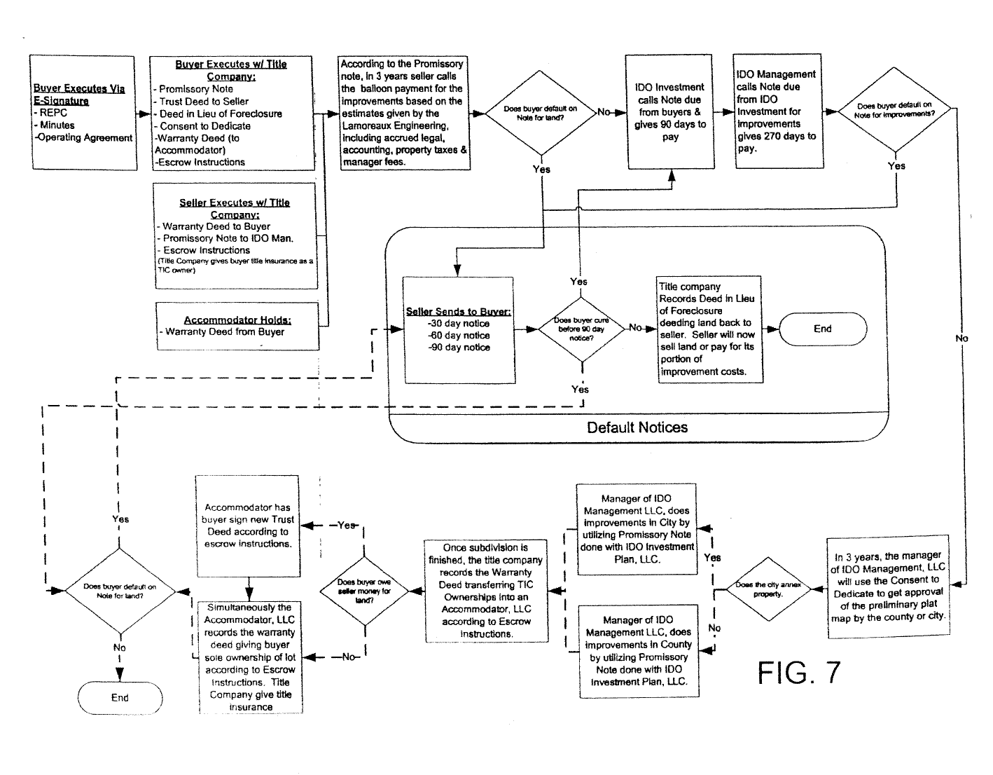

FIG. 7 is a flow chart illustrating an exemplary real property investment, development, and sales process according to another embodiment. In this embodiment, the coordinator 410 is called “IDO Investment,” “IDO Investment Plan, LLC” or “Seller,” the development company 420 is called “IDO Management” or “IDO Management, LLC,” the development manager 416 is called “IDO Man.,” “manager of IDO Management, LLC” or “Lamoreaux Engineering,” and the accommodator 418 is called “Accommodator, LLC” or “Accommodator.” An artisan will recognize that each of the foregoing entities may be one or more separate entities. An artisan will also understand that the process shown in FIG. 7 is provided by way of example only, and that the documents and terminology referenced in FIG. 7 are to be understood from the disclosure herein.

While specific embodiments and applications of the disclosure have been illustrated and described, it is to be understood that the disclosure is not limited to the precise configuration and components disclosed herein. For example, in one embodiment, the buyers 412, 413 do not purchase interests as tenants in common. Rather, the buyers 412, 413 may purchase ownership in a legal entity that owns the real property, develops the real property, and divides the real property among the buyers 412, 413 as sole owners after the property is developed. Such an entity may be, for example, a real estate investment trust (REIT), a corporation, a limited liability company, a partnership, or other business entity. Such an entity may have an agreement to dissolve after the improvements to the real property are complete and transfer sole ownership of reserved lots to the buyers 412, 413.

Various modifications, changes, and variations apparent to those of skill in the art may be made in the arrangement, operation, and details of the methods and systems of the disclosure without departing from the spirit and scope of the disclosure. Thus, it is to be understood that the embodiments described above have been presented by way of example, and not limitation, and that the invention is defined by the appended claims.

What is claimed is:

1. A method for selling real estate, comprising:
agreeing to sell a first portion of a real property to a first buyer for a first purchase price;
agreeing to sell a second portion of the real property to a second buyer for a second purchase price, wherein the first buyer recommended the purchase of the second portion of the real property to the second buyer;
agreeing to sell a third portion of the real property to a third buyer for a third purchase price, wherein the second buyer recommended the purchase of the purchase of the third portion of the real property to the third buyer;
upon selling the second portion of the real property to the second buyer, providing a first discount of the first purchase price to the first buyer; and
upon selling the third portion of the real property to the third buyer, providing a second discount of the first purchase price to the first buyer.

2. The method of claim 1, wherein the second discount is less than the first discount.

3. The method of claim 1, further comprising, upon selling the third portion of the real property to the third buyer, discounting the second purchase price for the second buyer.

4. The method of claim 1, wherein agreeing to sell the respective portions of the real property comprises agreeing with the buyers that the respective portions of the real property will be held by the all of buyers as tenants in common.

5. The method of claim 4, further comprising allowing each respective buyer to select their respective portion of the real property prior to becoming tenants in common.

6. The method of claim 1, further comprising agreeing with each buyer that, as a condition of the sale of a respective portion of the real property, each buyer will pay a proportionate share of a development cost to make an improvement to the real property.

7. The method of claim 6, wherein making the improvement comprises providing one or more of roads, common areas, and utilities on the real property.

8. The method of claim 6, wherein the respective purchase prices include the proportionate share of the development cost of the improvement.

9. The method of claim 6, further comprising:
providing an estimated cost to each buyer for their proportionate share of the development cost; and
paying a portion of an actual development cost that exceeds the estimated cost.

10. The method of claim 6, further comprising transferring sole ownership of at least a subset of each respective portion of the real property to each respective buyer after making the improvement.

11. A method for selling real estate, comprising:
soliciting a first contract from a first buyer to buy a first portion of a real property;
soliciting a second contract from a second buyer to buy a second portion of the real property, the second buyer being referred by the first buyer; and
soliciting a third contract from a third buyer to buy a third portion of the real property, the third buyer being referred by the second buyer;
upon closing the second contract, applying a first discount to a purchase price associated with the first contract; and
upon closing the third contract, applying a second discount to the purchase price associated with the first contract.

12. The method of claim 11, further comprising, upon selling the third portion of the real property to the third buyer, applying a third discount to the purchase price associated with the second contract.

13. The method of claim 11, wherein the contracts include an agreement that the buyers will own the real property as tenants in common.

14. The method of claim 11, wherein the contracts include an agreement that each buyer will pay a proportionate share of a development cost to make an improvement to the real property.

15. The method of claim 14, wherein the proportionate share of each buyer comprises a guaranteed estimate of the development cost allocated to the respective buyer.

16. The method of claim 14, wherein the contracts further include an agreement that, after the improvement is made to the real property, the buyers will transfer sole ownership of one or more reserved lots to each of the buyers.

17. The method of claim 16, wherein each contract indicates the one or more reserved lot selected by the respective buyer.

18. The method of claim 16, wherein the contracts further include an agreement that each buyer will transfer their respective ownership portions to a third party that will then transfer the sole ownership of the one or more reserved lots to each of the buyers.

19. A method for real estate investment, development, and ownership, comprising:
selling an interest in a real property to a first buyer, wherein the first buyer agrees, as a condition of the sale, to pay for a portion of an improvement to the real property in proportion to the first buyer's interest;
reserving a portion of the real property for the first buyer, and
upon completion of the improvement of the real property, transferring sole ownership of the reserved portion to the first buyer.

20. The method of claim 19, wherein the interest is a tenancy in common with at least a second buyer.

21. The method of claim 19, wherein transferring sole ownership the reserved portion to the first buyer comprises:
transferring ownership in the real property, the ownership including the first buyer's interest, to a third party; and
transferring ownership in the reserved portion from the third party to the first buyer.

22. The method of claim 21, wherein transferring the ownership in the real property to the third party comprises executing but not recording a first deed that transfers the first buyer's interest in the real property to the third party.

23. The method of claim 22, further comprising, upon completion of the improvement of the real property:
recording the first deed; and
executing a second deed that transfers the sole ownership of the reserved portion to the first buyer.

24. The method of claim 23, wherein recording the first deed and executing the second deed is done pursuant to escrow instructions given to the third party at the time of the selling of the interest to the first buyer.

25. The method of claim 19, wherein the improvement comprises one or more of roads, common areas, and utilities.

26. The method of claim 19, wherein a purchase price of the interest includes the proportionate share of the development cost of the improvement.

27. The method of claim 26, wherein the development cost comprises a guaranteed estimate of the improvement to the real property.

28. The method of claim 19, wherein the first buyer's interest in the real property is greater than the reserved portion ultimately transferred to the first buyer, the difference between the undivided interest and the reserved portion being used for one or more of roads and common areas.

29. The method of claim 19, further comprising allowing the first buyer to select the reserved portion before purchasing the interest.

30. The method of claim 19, further comprising in response to selling an interest in the real property to a second buyer referred by the first buyer, discounting a purchase price of the interest of the first buyer.

31. The method of claim 30, further comprising in response to selling an interest in the real property to a third buyer referred by the second buyer:
discounting a purchase price of the interest of the second buyer; and
further discounting the purchase price of the interest of the first buyer.

32. A method for real estate investment, development, and ownership, comprising:
selling respective undivided interests in a real property to a plurality of buyers, each buyer agreeing, as a condition of the sale, to pay for a portion of an improvement to the real property in proportion to the buyers' interests;
reserving respective portions of the real property for each buyer, the respective portions being selected by each buyer prior to purchasing the undivided interests;
temporarily transferring the buyers' interests in the real property to a third party until the improvement is made to the real property; and
upon completion of the improvement of the real property, transferring sole ownership of the respective reserved portions to the respective buyers.

33. A method for real estate investment, development, and ownership, comprising:
executing a first deed to a first buyer, the first deed granting an undivided interest in a real property with at least a second buyer;
entering a contract with the first buyer that, upon executing the first agreement, the first buyer will execute but not record a second deed transferring the first buyer's undivided interest in the real property to a third party;
instructing the third party to hold the second deed until an improvement to the real property is complete, wherein the first buyer pays a proportionate share of a cost of the improvement; and
upon completion of the improvement, instructing the third party to execute a third deed transferring sole ownership of a reserved portion of the real property from the third party to the first buyer.

34. A method for real estate investment, development, and ownership, comprising:
receiving a first deed from a first buyer granting a first interest in a real property;
receiving a second deed from a second buyer granting a second interest in the real property;
holding, without recording, the first deed and the second deed until an improvement to the real property is complete, the improvement paid for by the first buyer and the second buyer; and
upon completion of the improvement to the real property, transferring sole ownership of a first reserved portion to the first buyer and a second reserved portion to the second buyer.
